(19) United States
(12) Patent Application Publication
(10) Pub. No.: US 2001/0023499 A1
(43) Pub. Date: Sep. 20, 2001

(54) Airborne passenger service system

(75) Inventor: Hiroshi Wakahara, Nara (JP)

Correspondence Address: McDERMOTT, WILL & EMERY, 600 13th Street, N.W., Washington, DC, 20005-3096, US

(73) Assignee: Matsushita Electric Industrial Co., Ltd.

(21) Appl. No.: 09/798,941

(22) Filed: Mar. 6, 2001

(30) Foreign Application Priority Data
Mar. 9, 2000 (JP) P2000-65028
Mar. 9, 2000 (JP) P2000-65029

(51) Int. Cl. H04N 7/16

(52) U.S. Cl. 725/143; 725/76; 725/74

(57) ABSTRACT

A configuration comprising a plurality of individual seat apparatuses which output operation signals from operation switches for flight attendant call and for reading, the first and the second lights for flight attendant call and for reading, first distributors for outputting light control information which corresponds to an operation signal from each of said operation switches, first and second driving apparatuses that drive said first and second lights and second distributors for distributing light signals for flight attendant call or for reading to the driving apparatuses in response to the light control information from said first distributors.

### BACKGROUND OF THE INVENTION

1. Field of the Invention

The present invention relates to an airborne passenger service system (hereinafter referred to merely as “system”).

2. Description of the Related Art

In a system adopted for a large aircraft or the like, conventionally information about equipments, including information with respect to seat equipment installed in individual seat sides, is integrally controlled by a central controller of the fuselage side through software.

Operation switches for flight attendant call lights and individual reading lights are provided in the seat equipment.

These lights are, respectively, installed in a proper location within the fuselage separated from the control switches.

For example, in cases where an operation switch for reading is operated by a passenger, the operational information is transmitted once to the central controller via wires.

The central controller reads out seat position information and information of turning on or off the reading light included in this operational information. In the central controller, a necessary process is carried out based on the read information. Then, an instruction signal is transmitted from the central controller via the wires in order to turn on or off the above light.

In this manner, the operational information needs to be transmitted once to the central controller and, therefore, a considerable amount of time is spent until the light is turned on after the operation switch is operated. Though described in detail below, according to a calculation result by the present inventors, for example, 0.40 seconds are spent.

Here, the central controller needs to process not only information for the control of the turning on and off of the reading lights but also has to process other information. Therefore, even if operational information from an operation switch is inputted, sometimes the operational information cannot be responded to immediately. In such a case, additional time is spent before software processing is carried out for the operational information so that an instruction signal for turning on is sent to the reading light and this reading light is actually turned on.

Accordingly, from the point of view of the passenger, the response time becomes long since the operation switch for flight attendant call or for reading is operated before the corresponding light is turned. As a result, there are some cases the passenger feels that the operation of the operation switch has not been conveyed.

Therefore, there is room for the improvement of the quality of service by increasing the operational touch of these switches.

### SUMMARY OF THE INVENTION

Accordingly it is a main object of the present invention to provide a system which can offer a better attendant service for passengers by improving an operational feeling of the switches for flight attendant call and for reading.

Other objects, characteristics and advantages of the present invention will become clear from the description below.

A system according to the present invention, comprises a plurality of individual seat apparatuses which comprise operation switches for, at least, flight attendant call and reading and which respectively output operational signals for each of the operation switches, a first light installed in a proper location within an aircraft for flight attendant call, a second light installed in a proper location within the aircraft for reading, a first distributor which is connected to each of said individual seat apparatuses and which outputs operation control information corresponding to an operational signal from each of said operation switches, a first driving apparatus for driving said first light, a second driving apparatus for driving said second light and a second distributor which is connected to said first distributor and which distributes a light signal to said first driving apparatus when said operation control information from said first distributor is for flight attendant call and distributes a light signal to said second driving apparatus when said operation control information is for reading.

In the above description, the signal with respect to the operation of an operation switch for flight attendant call or for reading is directly sent to said two driving apparatuses via said two distributors without passing through the fuselage side central controller. Thus, the time required to turn on or off the lights after the operation of the operation switches, can be shortened.

### BRIEF DESCRIPTION OF THE DRAWINGS

These and other objects as well as advantages of the invention will become clear by the following description of preferred embodiments of the invention with reference to the accompanying drawings, wherein:

FIG. 1 is a block diagram of a system according to a first preferred embodiment of the present invention;

FIG. 2 is a schematic side view of seat wires in the system of FIG. 1;

FIG. 3 is a block diagram of a system according to a second preferred embodiment of the present invention;

FIG. 4 is a seat wire pattern diagram in the system of FIG. 3; and

FIG. 5 is a schematic side view of seat wires in the system of FIG. 3.

In all of these figures, like components are indicated by the same numerals.

### DETAILED DESCRIPTION OF THE INVENTION

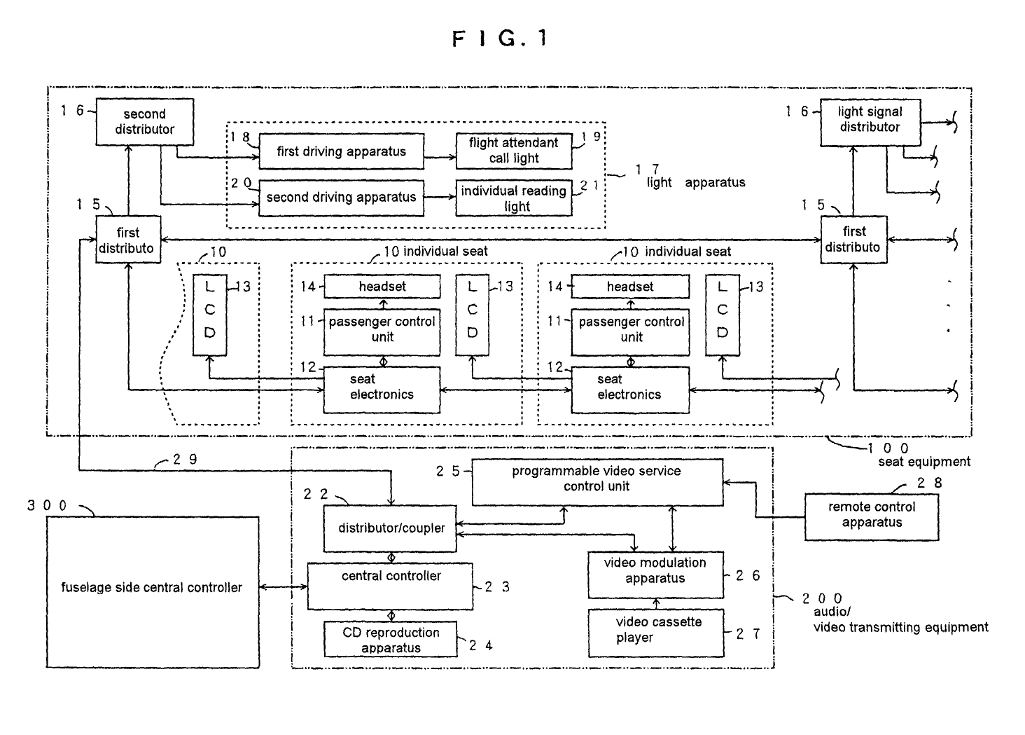

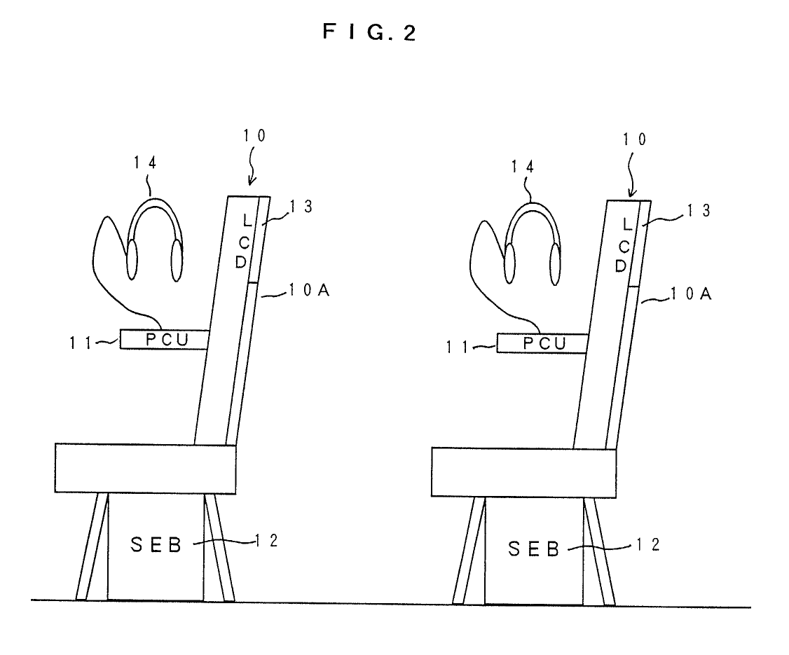

A system according to a first preferred embodiment of the present invention will be described with reference to FIGS. 1 and 2.

The present system comprises seat equipment 100, audio/video transmitting equipment 200 and a fuselage side central controller 300.

The seat equipment 100 is provided with individual seat apparatuses 10, first distributors 15, second distributors 16 and light apparatuses 17.

Each individual seat apparatus 10 includes a passenger control unit 11, a seat electronics 12, a liquid crystal display (LCD) 13 and a headset 14.

The passenger control unit 11 is provided with operation switches for flight attendant call and for reading, an audio/video selection switch and a channel selection switch.

The seat electronics 12 is connected to the passenger control unit 11 to detect an operational signal from each of the operation switches of the passenger control unit 11 and to transmit the operational signal to the first distributor 15 together with a seat identification signal from the passenger control unit 11.

The seat electronics 12 is also arranged for some number of individual seat apparatuses 10 which are in line along the lateral direction with respect to the fuselage axis direction of the aircraft and is connected to the first distributor 15.

The first distributor 15 receives operational signals from the seat electronics 12 and, in cases where those operational signals relate to a music request or to a video request, these signals are, together, conveyed to the audio/video transmitting equipment 200 via a cable 29.

In the case that those operational signals relate to turning on and off of the lights for flight attendant call or for reading, the first distributor 15 also extracts those operational signals and then outputs light control information to the second distributor 16.

There are a plurality of block units each of which is composed of a predetermined number of individual seat apparatuses 10 arranged in the fuselage axis direction.

Each first distributor 15 is arranged for each of said block units and is connected in series to each other with respect to the audio/video transmitting equipment 200 via the cable 29.

The second distributor 16 distributes each of the light signals for flight attendant call and for reading to the light apparatus 17 in accordance with light control information from the first distributor 15.

The light apparatus 17 is provided with first and second driving apparatuses 18, 20, a flight attendant call light 19 and an individual reading light 21.

These driving apparatuses 18, 20 each drives the corresponding lights 19, 21 in accordance with the light signals from the second distributor 16.

The audio/video transmitting equipment 200 is provided with a distributor/coupler 22, a central controller 23, a CD reproduction apparatus 24, a programmable video service control unit 25, a video modulation apparatus 26 and a video cassette player 27. A remote control apparatus 28 is attached to the audio/video transmitting equipment 200.

The central controller 23 receives an operational signal from an individual seat apparatus 10 together with the seat identification signal via the first distributor 15 and the distributor/coupler 22 and transmits the signals to the fuselage side central controller 300.

The first distributor 15 of the seat equipment 100 and the distributor/coupler 22 of the audio/video transmitting equipment 200 are connected via the cable 29 to each other.

The controller 300 and the second distributor 16 are not connected. Instead of that, the first distributor 15 and the second distributor 16 are directly connected. Thereby, light control information is outputted to the second distributor 16 from the first distributor 15.

The seat electronics 12 are arranged in the lower part of a seat.

The passenger control unit 11 is mounted on the arm rest of the seat.

The headset 14 is connected to a headset jack in the passenger control unit 11.

The liquid crystal display 13 is provided on the backside 10A of a front seat and is connected to the seat electronics 12 via a power supply/signal transfer cable (which is not shown.)

In operation, a flight attendant call switch of the passenger control unit 11 is operated by a passenger. An operational signal thereof passes through the seat electronics 12 from the passenger control unit 11 and is transmitted to the first distributor 15 together with the seat identification signal of the individual seat apparatus 10.

In the first distributor 15 operational signals with respect to the turning on or off of the lights for flight attendant call or for reading are extracted from among the operational signals sent from the seat electronics 12 of the individual seat apparatuses 10 in accordance with the operation of the passenger. Light control information corresponding to the extraction is directly inputted to the second distributor 16. The second distributor 16 responds the input of the light control information and outputs the light signal to the first driving apparatus 18. The first driving apparatus 18 is driven by the light signal from the second distributor 16. Thereby, the flight attendant call light 19, corresponding to the seat, is turned on or off.

When the switch for the individual reading light 21 is operated by the passenger, the individual reading light 21 corresponding to the seat of the passenger is turned on or off in the same manner as above.

No operational signals concerning both the flight attendant call light 19 and the individual reading light 21 are sent to the fuselage side central controller 23.

Accordingly, it is not necessary to wait for the light control information to be sent to the second distributor 16 from the central controller 23 and that operational signal is directly outputted to the second distributor 16 from the first distributor 15.

Thereby, the time is shortened before a desired light is actually turned on or off, after the operation of the turning on or off of those lights 19, 21. As a result, the operational feeling of the switches for turning on or off those lights 19, 20 is improved.

Signal transmission from the first distributor 15 to the central controller 23 and signal transmission from the central controller 23 to the second distributor 16 become unnecessary. Thereby, software management becomes simplified.

The flight attendant call lights 19 are provided so as to be used in common by several seats while the individual reading lights 21 are provided for individual seats.

The above description relates to the operation for flight attendant call and for reading. Other operations are described in the following.

Through the selection operation of audio/video or a channel in the passenger control unit 11, transmission of the desired music or video image to the audio/video transmitting equipment 200 is requested.

When a passenger desires to listen to music, an operation of requesting music is carried out in the passenger control unit 11. A selection of music is also carried out. In addition, a selection of stereo or monaural is also carried out. Such a request signal is detected by the seat electronics 12 and is given to the central controller 23 via the first distributor 15, the cable 29 and the distributor/coupler 22, respectively. Thereby, a CD reproduction apparatus 24 is driven by the central controller 23.

The central controller 23 acquires seat information, through data processing done together with the fuselage side central controller 300, of which individual seat apparatus 10 has made a request. Then, an audio signal reproduced by the drive control of the CD reproduction apparatus 24 is outputted, from the seat electronics 12 corresponding to the seat information via the return path, to the headset 14.

When a passenger desires to see a video program, an operation of requesting a video image is carried out in the passenger control unit 11. Furthermore, a program selection operation is carried out. In addition, a selection operation of stereo or monaural or a selection operation from among multiple languages are also carried out.

Such a request signal is detected by the seat electronics 12 and is given to the control unit 25 via the first distributor 15, the cable 29 and the distributor/coupler 22.

Thereby, the video modulation apparatus 26 and the video cassette player 27 are driven by the control unit 25.

The central controller 23 acquires seat information, through data processing done together with the fuselage side central controller 300, of which the individual seat apparatus 10 has made a request. Then, a video signal and an audio signal reproduced through the drive control by video cassette player 27 are conveyed to the seat electronics 12 which correspond to the seat information via the return path.

Thereby, a video image is displayed on the liquid crystal display 13 and, at the same time, an audio is outputted from the attached earphone.

In this manner, a passenger service of video-on-demand is offered.

Next, the above-described first embodiment and a conventional case are compared with respect to the period of time after the flight attendant call switch or individual reading light switch in the passenger control unit 11 is operated by a passenger and before the operation of the turning on or off of the flight attendant call light 19 or the individual reading light 21 is actually implemented.

(1) Conventional Case

Seat electronics data are formed of 4 bytes. One byte is 8 bits and the start bit and the stop bit are 1 bit each. Accordingly, data for one seat are 4×10 bits=40 bits. Those data are transmitted from the seat electronics 12 to the first distributor 15.

The bit number of data transmitted from one unit of seat electronics 12 is 40 bits. 16 units of seat electronics 12 are assumed to be connected to one first distributor 15, the total bit number becomes 40×16=640 bits.

The transmission speed from the seat electronics 12 to the first distributor 15 is assumed to be 9600 bps. As a result, the period of time required to transmit data from the seat electronics 12 to the first distributor 15 becomes 640/9600 [symbol] 0.07 sec.

Then, the period of time required to transmit data to the central controller 23 via the cable 29 from the first distributor 15 is 40 bits for the distributor data. This becomes 320 bits when the address is “8,” which is divided by the transmission speed 9600 bps so as to gain 0.03 sec.

In addition, 0.2 sec is required between the central controller 23 and the fuselage side central controller 300. 0.1 sec is required from the fuselage side central controller 300 to the second distributor 16.

As a result of the above, the total required time is 0.07+0.03+0.2+0.1=0.40 (sec).

(2) Case of the First Embodiment

The total bit number from the seat electronics 12 to the first distributor 15 is 640 bits, which is the same as the above. The period of time required for that transmission is 0.07 sec. Then, as for the data transmission from the first distributor 15 to the second distributor 16, which is directly carried out, the distribution data are 40 bits. That becomes 320 bits when the address is assumed to be 8 and, therefore, the period of time becomes 0.03 sec. As a result, the total required time is 0.07+0.03=0.10 (sec).

That is to say, in the case of the first embodiment, the required time is shortened to ¼ of that of the prior art. In addition, the data contents are restricted to one port of the first distributor 15 so that the operation time becomes shorter.

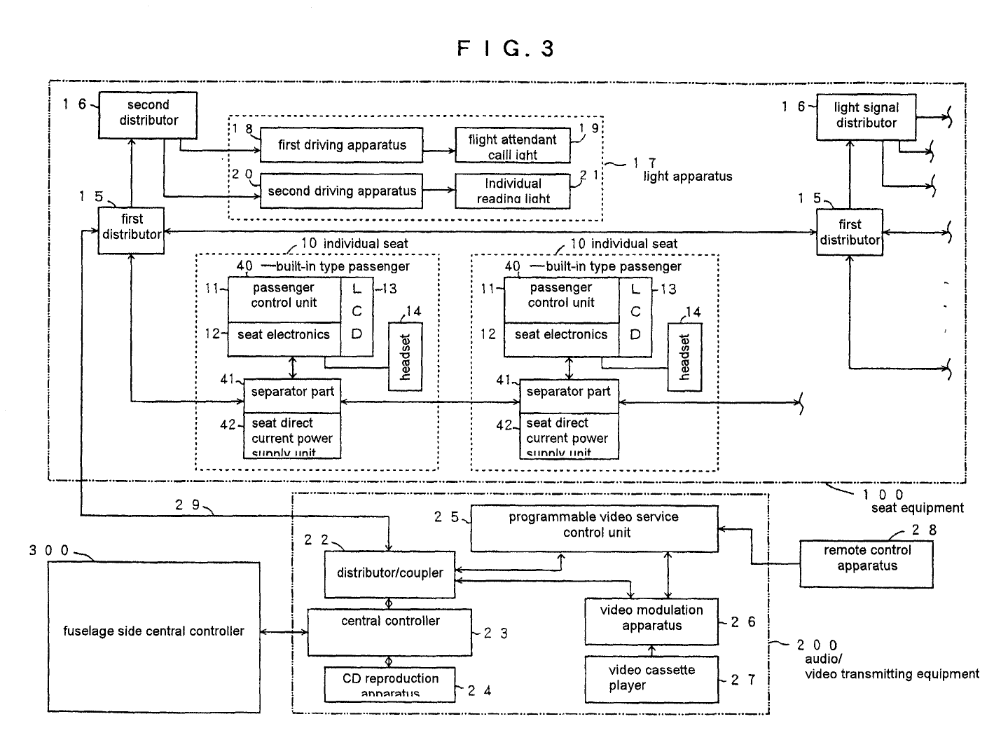

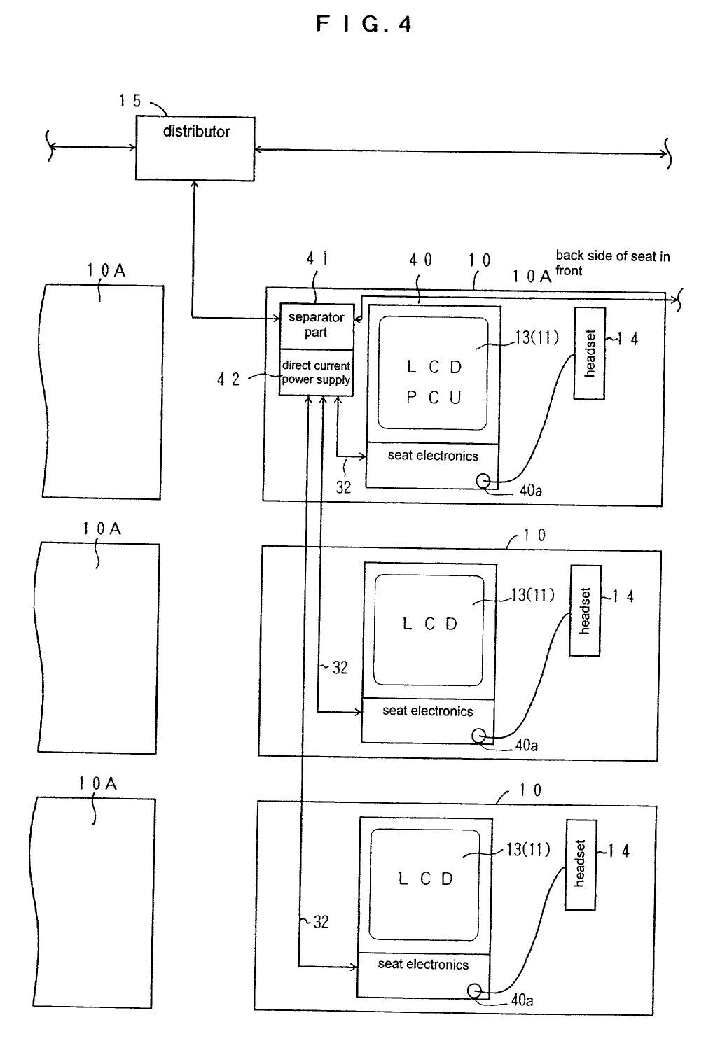

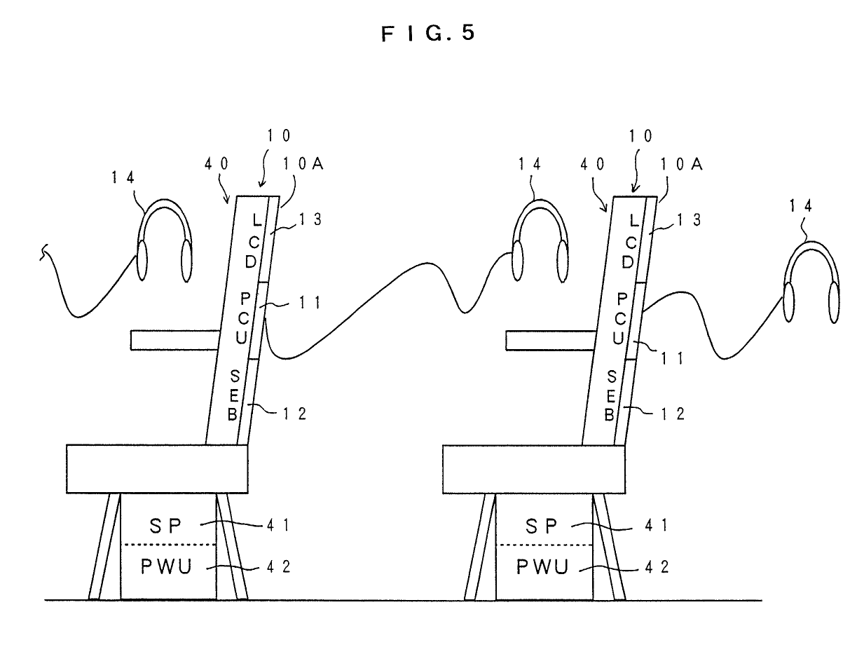

Next, a system according to the second preferred embodiment of the present invention is described with reference to FIGS. 3 to 5.

The individual seat apparatus 10 in the system of the second embodiment is provided with a built-in type passenger operation apparatus 40. This operation apparatus 40 is formed by integrating a passenger control unit 11, a liquid crystal display 13 and seat electronics 12.

The seat electronics 12 are provided with a headset jack 40a, to which a headset 14 is connectable.

The liquid crystal display 13 is formed as a touch panel type.

The touch operation signal of the liquid crystal display 13 is processed by the passenger control unit 11. The result of this process is displayed on the liquid crystal display 13.

The liquid crystal display 13 comprises, in its touch panel, an audio/video selection switch, a channel selection switch, an attendant call switch and a reading light switch.

A separation unit 41 is arranged for the individual seat apparatus 10. Each separation unit 41 for respective individual seat apparatuses 10 are connected to each other in series and is connected to the first distributor 15.

The cable 29 includes an alternating current power supply system so that the first distributor 15 also distributes the alternating current power supply system.

The direct current power supply unit 42 is provided by being distributed from the first distributor 15 and is arranged for the separation unit 41. A direct current power source is supplied to each individual seat apparatus 10 from the direct current power supply unit 42.

A power supply/signal cable 32 is wired between the separation unit 41, the direct current power supply unit 42 and the seat electronics 12. The power supply/signal cable 32 has a simple wiring form.

The operation apparatus 40 and the headset 14 of the individual seat apparatus 10 are equipped in a back side 10A of a front seat.

Next, the operation is described.

The passenger control unit 11 carries out an audio/video selection operation or a channel selection operation. Thereby, transmission of the desired music is requested for the audio/video transmitting equipment 200 or transmission of the desired video image is requested.

A passenger who desires to listen to music carries out a music request operation or music selection operation and, in addition, stereo/monaural operation on the touch panel of the liquid crystal display 13 which is in the back side part 10A of the front seat for the corresponding individual seat apparatus 10.

Such request signals are detected by the passenger control unit 11 so as to be given to the central controller 23 via the seat electronics 12, the separation unit 41, the first distributor 15, the cable 29 and the distributor/coupler 22. Thereby, the CD reproduction apparatus 24 is driven.

A passenger who wishes to see a video program carries out a video request operation, a program selection operation, a stereo/monaural selection operation and a multiple language selection operation on the touch panel of the liquid crystal display 13 in the back side part 10A of the front seat for the corresponding individual seat apparatus 10.

Such request signals are detected by the passenger control unit 11 and are given to the control unit 25 via the seat electronics 12, the separation unit 41, the first distributor 15, the cable 29 and the distributor/coupler 22.

This control unit 25 drives the video modulation apparatus 26 and the video cassette player 27.

The central controller 23 acquires seat information, through data processing done together with the fuselage side central controller 300, of which the individual seat apparatus 10 has made a request. Then, the video signal and the audio signal reproduced through the drive control by the video cassette player 27 are conveyed to the seat electronics 12 which correspond to the seat information via the return path so as to be displayed as a video on the liquid crystal display 13 and to be outputted as an audio from the attached earphone.

Thereby, a passenger service of video-on-demand is offered.

A passenger who calls a flight attendant or who reads operates a switch for a flight attendant call or for reading on the touch panel of the liquid crystal display 13.

The direct current power supply unit 42 converts the alternating current power received from the first distributor 15 into direct current power. Thereby, a direct current power source is supplied to a personal computer or to a game device and, as a result, a variety of passenger services are offered.

As described above, a touch panel of an individual seat apparatus 10, a liquid crystal display 13 and a headset 14 are arranged in the back side part 10A of the front seat so that a passenger control unit 11 and seat electronics 12 are made to be a built-in type passenger operation apparatus 40 in a block unit which is arranged in the front seat.

Thereby, no wires are provided to join front seats to seats in back. The wire length becomes shorter in the individual seat apparatus 10. The wires are collected together. As a result, the entire wiring form is simplified.

As a result, the space around a seat can be broadened so as to relieve the crowded feeling of the passenger. Passenger comfort is also improved.

In addition, the working environment for the first wiring construction or the maintenance is improved. Labor costs are also reduced.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An airborne passenger service system comprising:
a plurality of individual seat apparatuses each of which comprises operation switches for flight attendant call and for reading and each of which outputs an operation signal from each of said operation switches;
a first light installed in a proper location within an aircraft for flight attendant call;
a second light installed in a proper location within the aircraft for reading;
a first distributor connected to each of said individual seat apparatuses so as to output light control information corresponding to an operation signal from each of said operation switches;
a first driving apparatus for driving said first light in response to a first light signal;
a second driving apparatus for driving said second light in response to a second light signal; and
a second distributor connected to said first distributor, said second distributor distrebuting said first light signal to said first driving apparatus in the case that light control information from said first distributor is for flight attendant call and distributing said second light signal to said second driving apparatus in the case that the light control information from said first distributor is for reading.

2. The airborne passenger service system according to claim 1, wherein
a plurality of said individual seat apparatuses are arranged in line from the front to the rear in a fuselage axis direction of said aircraft;
each of the individual seat apparatuses comprises a passenger control unit, a seat electronics and a liquid crystal display;
said passenger control unit includes an operation switch for requesting a video image in addition to said operation switches for flight attendant call and for reading and is mounted in an arm rest of a seat;
said seat electronics detects said operation signals from said operation switches and transmits to said first distributor; and
said liquid crystal display is provided in a back side of a front seat and displays a video program according to a selection operation for requesting said video image in said passenger control unit of a back seat.

3. The airborne passenger service system according to claim 2, wherein a headset is connected to said passenger control unit.

4. The airborne passenger service system according to claim 1, wherein a plurality of seat apparatuses are arranged in line from the front to the rear in a fuselage axis direction of said aircraft;
each of said seat apparatuses includes a passenger control unit and a liquid crystal display;
said passenger control unit and said liquid crystal display are mounted on the back side of a front seat;
said passenger control unit comprises operation switches for flight attendant call, reading and video image request, said passenger control unit being touch-operated; and
said liquid crystal display displays a video program according to a selection operation for requesting a video image.

5. The airborne passenger service system according to claim 1, wherein a plurality of said individual seat apparatuses are arranged in line from the front to the rear in a fuselage axis direction of said aircraft;
each of said individual seat apparatuses includes a passenger control unit, a seat electronics, a liquid crystal display and a separation unit;
said passenger control unit, said seat electronics and said liquid crystal display are integrated in one unit and are mounted on the back side of a front seat;
said passenger control unit comprises operation switches for flight attendant call, for reading and for requesting video images, said passenger control unit being touch-operated;
said seat electronics detects said operation signals from said operation switches of said passenger control unit and transmits to said separation unit;
respective separation units of each of said individual seat apparatuses are connected to each other with respect to said first distributor; and
said liquid crystal display displays a video program according to a selection operation for requesting a video image.

6. The airborne passenger service system according to claim 1, wherein
said individual seat apparatuses are arranged in line from the front to the rear in a fuselage axis direction of said aircraft;
each of said individual seat apparatuses comprises a built-in type passenger control apparatus, a separation unit and a direct current power supply unit;
said built-in type passenger control apparatus integrates a passenger control unit, a seat electronics and a liquid crystal display and is mounted on a back side of a front seat;
said passenger control unit comprises operation switches for flight attendant call, for reading and for requesting video images, said passenger control unit being touch-operated;
said seat electronics detects operation signals from said operation switches of said passenger control unit and transmits to said separation unit;
said liquid crystal display displays a video program according to a selection operation for requesting a video image;
said direct current power supply unit is connected to said individual seat apparatus and supplies direct current power to said individual seat apparatus; and
respective separation units of each of said individual seat apparatuses are connected in series to each other with respect to said first distributor.

7. The airborne passenger service system according to claim 6, wherein headsets attached to said seat are connected to said seat electronics.
